(19) United States
(12) Patent Application Publication
(10) Pub. No.: US 2008/0174128 A1
(43) Pub. Date: Jul. 24, 2008

(54) Mitt-like glove for the collection and disposal of pet excrement

(76) Inventor: Arrigo D. Jezzi, Bala Cynwyd, PA (US)

Correspondence Address: ARRIGO D. JEZZI, 169 UPLAND TERRACE, BALA CYWNYD, PA, 19004, US

(21) Appl. No.: 11/655,514

(22) Filed: Jan. 20, 2007

(51) Int. Cl. A01K 29/00

(52) U.S. Cl. 294/1.3

(57) ABSTRACT

A mitt-like disposable glove for collecting and disposing of pet excrement or other waste is shown. The mitt-like glove is constructed of layers of impermeable polymeric material, with the front surface of the glove substantially covered with a thicker material that may be absorbent. The mitt-like glove may be made of materials that are compostable, biodegradable, anti-microbial and/or scented. Designed along the glove edges is a strip of material that can be used as a tie, or an adhesive strip which can be used to seal the top of the glove with the cut-outs of the handle. The mitt-like glove is capable of being everted over solid waste material, a contaminated article, or other refuse to enclose such material, and the attached tie may be utilized to close the access opening so that the mitt-like glove may function as a disposal bag for the refuse. The mitt-like glove has a cut out portion at the wrist area of the glove that may be used to carry the bag after it is filled.

### TECHNICAL FIELD OF THE INVENTION

This invention relates to a sanitary device, and specifically, to a polymeric mitt-like glove having a heat sealed or attached edge with a thicker and absorbent material on the outside surface of one side of the mitt-like glove, which is specifically designed to pick up pet excrement or other refuse, wherein the bag can be everted to facilitate disposal of the refuse in a sanitary manner.

### BACKGROUND OF THE INVENTION

Animals, like humans, need exercise to stay in good health. Many pet owners walk or jog with their dog around their neighborhood and various public parks. The pet owners, however, are often faced with the problem of what to do with their pet's excrement. Many municipalities have begun adopting ordinances that regulate the disposal of pet excrement and require the owner to clean up any droppings. Some pet owners carry some type of a shovel and a bag. Others use a scissor-like scoop. These inventions have demonstrated disadvantages. Some are difficult to use while holding onto the pet leash or have insufficient structural design to adequately retain the pet feces so that they do not fall onto the ground after being scooped up. These devices are also burdensome and heavy. It is a great inconvenience for pet owners to walk their dog while carrying a scoop or shovel. Thus, there is the need for a disposal system which is lightweight, easy to use, sanitary, environmentally friendly, and which adequately protects the pet owner from contamination.

Several types of disposal clean up bags have been developed. These bags are often difficult to operate. When the hand is inside the bag, it is difficult to get a proper grip on the excrement. Often the excrement slips around and cannot be properly picked up without additional manipulation from a free hand or by using another object such as a twig. Very often the user contaminates his or her hands in using these clean up bags. Further, there is often moisture associated with excrement. This moisture makes it even more difficult to properly pick up the excrement. Finally, these bags are often unpleasant to use because the user can feel the heat and texture of the excrement, creating the impression of contamination of the hands even if the bag is not breached during use.

Several ideas on the concept have been developed as far back as 1904, as in U.S. Pat. No. 774,489, where the inversion of a glove was first discussed. Many concepts discuss devices for the service of a hand device and a disposal vehicle for the dog feces in a sanitary manner. These include apparatuses such as scoops or shovels in conjunction with bags that are later used as disposal containers. The recent U.S. Pat. No. 6,237,971 discusses a bag device that is to be used as a glove, and U.S. Pat. No. 6,511,111 discusses a glove in which the fingers of the glove are webbed to provide a greater surface area for the collection of the soiled material.

Another array of prior art discusses the use of absorbent or thicker materials to assist in the collection of soiled substances to avoid the uncomfortable feel associated with the task. For instance, U.S. Pat. No. 4,788,733 discusses a glove covered with a layer of an absorbent material in which the absorbent layer is impregnated with a cleaning solution, something that is not needed for the task that the present invention is to perform. More recently, U.S. Pat. No. 4,964,188 discusses a similar concept but uses the absorbent enclosure like a bag to encompass an internal glove-like structure that has a pleat running along the side of the structure. Both of these concepts lack the unitary structure and simplicity of the disclosed device.

### BRIEF SUMMARY OF THE INVENTION

The present invention provides several advantages over other products for this type of use designs and over common practice. This invention is a disposable hand covering, such as a glove, mitten or, preferably, a digitless mitt, for the purpose of hand pick-up of various types of refuse or contaminated material, such as animal feces.

In particular, the mitt design of the present invention allows a one-size option that is suitable for use with either the right or left hand. The impermeable outer layers of the mitt provide protection to the user from contamination by fecal matter or other waste during the capture and containment process. The additional, absorbent layer has multiple functions, including providing a less slick surface for capturing the refuse or waste, and reducing the user's negative tactile sensations associated with the handling of waste. The mitt also provides a disposal bag, produced by simply using the other hand to evert the bag over the capture hand, providing for full containment of the refuse with effectively no opportunity for cross contamination or loss. The mitt is provided with ties, which are either attached to or are integral to the mitt in the area of the wrist opening, so that the inverted mitt can be secured for transport to and disposal in an appropriate receptacle. Additionally the mitt is provided with openings in the wrist area, which can be used as a carrying handle either before or after using the mitt to recover the waste or other refuse.

These and other advantages of the invention over the prior clean up devices will become more apparent after reading the description and claims that follow. It is anticipated that the mitt design of the present invention will have usefulness in the recovery and containment of other waste, refuse, or contaminated articles, including but not limited to pet or animal waste; grass, soil, leaves, or other surfaces contaminated by such waste; spoiled food products; and items soiled or otherwise contaminated by children or adults in public or private environments.

### BRIEF DESCRIPTION OF THE DRAWINGS

FIG. 1 illustrates one embodiment of the mitt-like glove of the present invention.

FIG. 2 illustrates another embodiment of the mitt-like glove of the present invention, highlighting the integral ties on the side of the glove.

FIG. 3 illustrates a cross-sectional view of the mitt-like glove of the present invention.

FIG. 4 illustrates another embodiment of the mitt-like glove of the present invention, where the absorbent layer covers only a portion of the glove surface.

FIG. 5 illustrates the mitt-like glove of the present invention being everted over waste grasped by the hand that is wearing the glove.

FIG. 6 illustrates the everted mitt-like glove being closed by the integral ties.

### DETAILED DESCRIPTION OF THE INVENTION

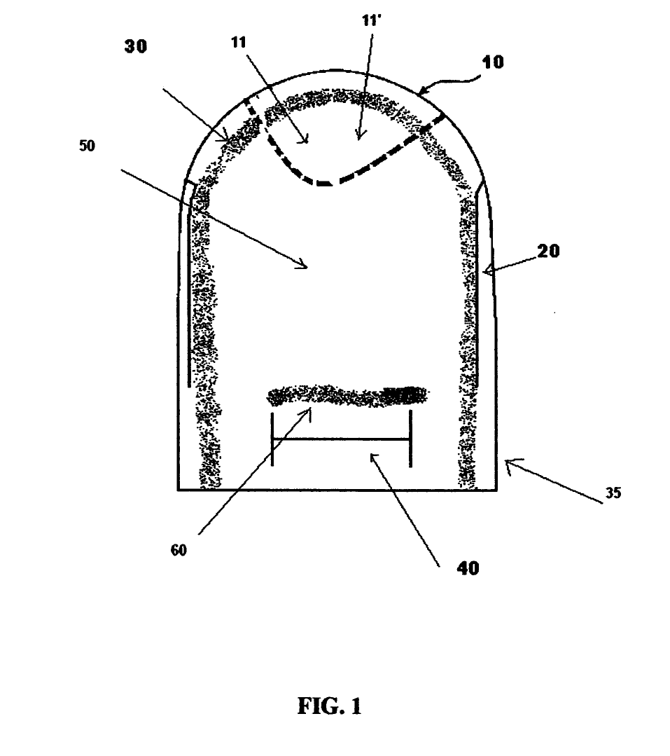

The invention relates to a clean up device, more particularly to a plastic mitt-like glove. One embodiment of the mitt-like glove is illustrated in FIG. 1. The mitt-like glove (10) comprising two layers of impermeable polymeric material (11 and 11′) such as polymer films or membranes, produced from any of numerous polymers, such as polyesters, polyolefins, polyacrylates, polyamides, or blends of the same, which prevents moisture from seeping in and contacting the hand. Each of these layers of polymer material may comprise one or more constituent layers, such as a bilayer film or membrane. The two polymer layers are heat sealed or bonded around the periphery to create a seam (30), excepting an opening (35) for the hand, which provides a pocket into which the hand can be inserted.

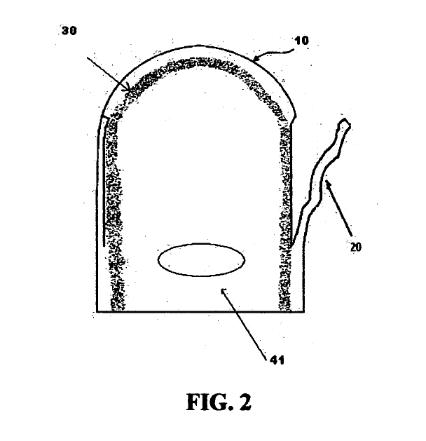

Between the bonded seam (30) and the outer edge of the mitt-like glove, integral ties or tie-down straps (20) are included. These tie-down straps are completely die cut from or are perforated along the sides of the glove, so the ties may be detached from the glove as illustrated in FIG. 2. A conveniently designed handle (40, 41) is provided at the wrist area of the glove to slip over the wrist when carrying the bag, either before or after use, thus freeing up both the owner's hands to handle the leash. This handle may be produced by two preferred methods, where a “T” like shape (40), as in FIG. 1, or a circular, elliptical, or oblong opening (41), as in FIG. 2, is conveniently cut into one or both of the outer layers, most preferably by some mechanical means. In another embodiment of this design, the cut-out material can be left on the product by having one side attached and then folded over onto an adhesive bead to provide another alternative for sealing the glove for disposal.

The peripheral seam (30) between the two layers is strong enough to provide sufficient integrity so that the product does not delaminate. Several methods of bonding are possible. These methods include, but are not limited to, thermal bonding, adhesive bonding, ultrasonic seaming and sewing where the needle holes are sealed by some secondary means.

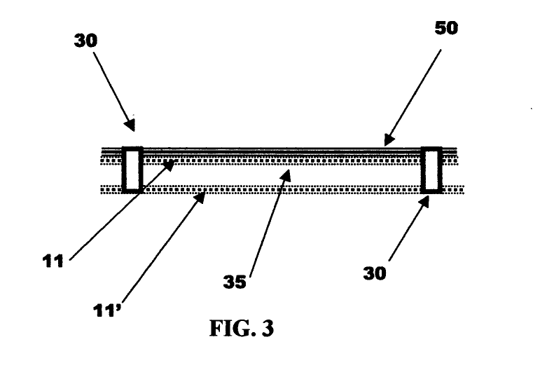

In another embodiment of the invention, a layer of another substrate material (50) is attached to the outer surface of the impermeable polymer film layers. This additional material, which is absorbent, may cover the outer surfaces of both layers of impermeable polymer film, or it may cover only a single outer surface of the mitt-like glove, i.e. the ‘palm’ side. A cross-section view of the mitt-like glove is shown in FIG. 3, viewed from the edge of the glove with the hand opening (35). The two layers of impermeable polymer material (11 and 11′) are shown, as are the layer of absorbent material (50) and the bonding seams (30). The gap (35) between the polymer film layers represents the hand opening and space within the mitt-like glove into which the hand of the wearer is inserted.

The material for the absorbent layer is preferably selected from the group of woven, knitted or nonwoven fabrics and paper-like products made primarily from cellulosic fibers. Heavy gauge tissue paper such as that used for kitchen paper towels, or an air-lay nonwoven is suitable as the absorbent material. In addition to absorbency, these materials have sufficient thickness and surface friction to assist in the retrieval and control of the refuse and serve protect the wearer from the heat and unpleasant feel associated with the task.

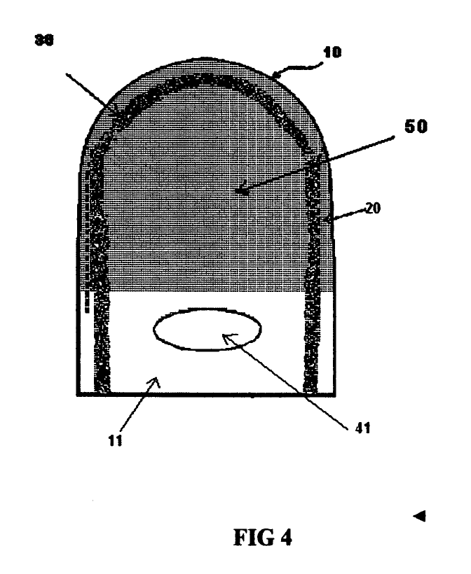

Another embodiment of the invention is shown in FIG. 4. Here, the layer of absorbent material (50) is attached to the outer surface of the impermeable polymer film layer only on the primary target use area. This target zone is defined as the fingertip to palm region of the mitt.

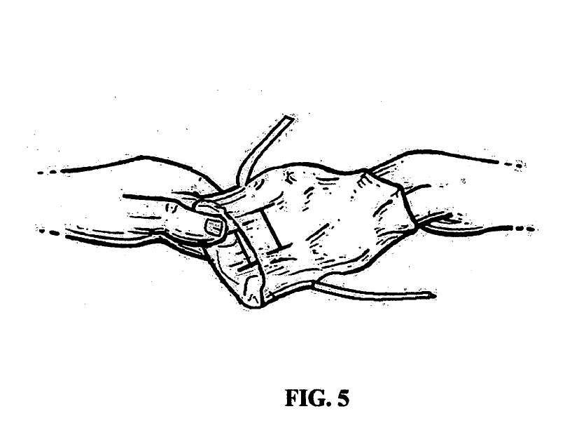

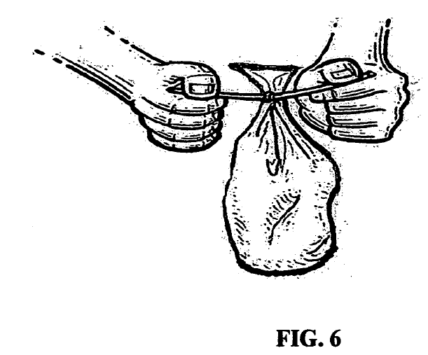

The mitt-like glove can be right or left handed as it only has one opening which is large enough for either right or left hand to be inserted through. The mitt-like glove is sized so that the glove can easily be everted over the hand (FIG. 5) once the excrement or refuse is picked up, thereby relocating the retrieved matter inside the disposable bag created by this process. The integral ties may be removed from the side edges of the mitt-like glove, and these ties can be used to tie the open end of the glove, sealing the material picked up inside the glove (FIG. 6) thereby converting the mitt-like glove into a disposable bag for transport to a suitable waste receptacle.

Another embodiment of an alternative sealing mechanism is shown in FIG. 1. Here one can fold down the cut-out of the “T,” shaped opening (40) fold it over a bead (60) of pressure sensitive adhesive. This would then provide an alternative method for sealing the device for disposal.

Another embodiment of the present invention provides for biodegradation of the pet excrement or refuse, as it would if left to nature, by using materials that are biodegradable and compostable to construct the mitt-like glove. Animal feces, though benignly biodegradable itself, becomes a burden to municipal solid waste systems when encased in a plastic bag for disposal. Therefore the impermeable polymer film layers (11 and 11′) of the present invention may comprise polyolefinic polymers such as polyethylene, polypropylene, and copolymers thereof, as well as other polymers such as polyesters, polyamides, or polyacrylates, or, most preferably, upon polymers that are biodegradable such as polyhydroxyalkanoates (PHA), or the more commercially available polylactic acid derived polymers (PLA) such as NatureWorks™ from Dow-Cargill or Bionelle™ from Showa High Polymer; or aliphatic co-polyesters such as Eastar-Bio™ from Eastman or EcoFlex™ from BASF. It is also anticipated that if the impermeable polymer film layers of the mitt-like glove are comprised of polyolefinic polymers, a biodegradable substance such as starch might be incorporated into the polymeric material. If such a biodegradable substance is added to the polymer, bacteria can attach the starch and allow the polymer film to disintegrate. Hence, the polymer layer breaks down and allows the contents enclosed within the mitt-like glove to return to nature.

In another embodiment of this invention, an enhanced degree of sanitary protection is provided to the user by incorporating an antimicrobial substance on or within the layer of material (50) that contacts the waste product. Antibacterial agents that can be included on the absorbent fiber substrates are known in the art, such as those discussed in U.S. Pat. No. 4,533,435, which discusses coating paper with halogenated aromatic nitrites, salts of imazalil sulphate; 2,5,3′,4′-tetracholorosalicylanilide; or dichlorophene. Other anti-bacterial formulations used on cellulosic substrates are discussed in U.S. Pat. No. 4,975,217, in which are presented germicidal compositions consisting of alkyl sulfonate salt and organic acids selected from the group of malic acid, citric acid and mixtures thereof These germicidal compositions not only can be applied directly to human skin, but can also be sprayed onto cellulosic substrate surfaces. The use of anti-bacterial compositions on the absorbent, cellulosic layer of the device is the preferred approach when the impermeable layers (11 and 11′) are comprised of biodegradable or compostable materials or designed to break down as a result of an organic ingredient, typically starch, that is added to the impermeable polyolefinic film.

When biodegradable polymers are used to produce the impermeable layers (11 and 11′) of the glove, other common antimicrobial compounds such as triclosans or triclocarbans can be incorporated directly into the polymer matrix. These chemicals provide antimicrobial function to the polymeric materials thus produced without negatively altering biodegradability of the materials.

Other embodiments of the present invention will be apparent to one skilled in the art.

What is claimed is:

1. A unitary disposable device for the collection of animal fecal matter or other waste and for the subsequent sanitary disposal thereof, comprising,
a. a mitt suitable for the insertion of a human hand, said mitt comprising at least a top layer and a bottom layer of an impermeable material,
b. wherein the outer edges of the mitt are sealed, excepting an opening for the hand, and
c. wherein a layer of an absorbent material is bonded to at least a portion of the outer surface of at least one of said top layer or said bottom layer, and
d. wherein one or more of said layers is treated with an antimicrobial treatment, and
e said mitt also having tie down strips or a sealing mechanism integral to the mitt, and
f. said mitt also having an opening in the wrist portion, which provides a carry, handle.

2. The mitt defined in 1 wherein said antimicrobial treatment to said layers is a halogenated aromatic nitrile, salts of imazalil sulphate; 2,5,3′,4′-tetracholorosalicylanilide; or dichlorophene.

3. The mitt defined in 1 wherein said antimicrobial treatment to said layers is a composition containing an alkyl sulfonate salt and organic acids selected from the group of malic acid, citric acid and mixtures thereof.

4. The mitt defined in 1 wherein said antimicrobial treatment to said layers is triclosan or triclocarban.

5. The antimicrobial treatment of 2 where the application of such treatment is either topical or by impregnation.

6. The antimicrobial treatment of 3 where the application of such treatment is either topical or by impregnation.

7. The antimicrobial treatment of 4 where the application of such treatment is either topical or by impregnation.

8. A unitary disposable device for the collection of animal fecal matter and for the subsequent sanitary disposal thereof, comprising,
a. a mitt suitable for the insertion of a human hand, said mitt comprising at least a top layer and a bottom layer of an impermeable material,
b. wherein the outer edges of the mitt are sealed, excepting an opening for the hand, and
c. wherein a layer of an absorbent material is bonded to at least a portion of the outer surface of at least one of said top layer or bottom layer, and
d. wherein one or more of said layers is treated with an antimicrobial treatment, and
e. wherein all layers comprise biodegradable or compostable materials, and
f. said mitt also having tie down strips or another sealing mechanism integral to the mitt, and
g. said mitt also having an opening in the wrist portion, which provides a carrying handle.

9. The mitt defined in 8 wherein the impermeable material is produced from a polymer chosen from the group: polylactic acid derived polyesters, aliphatic polyesters, polyhydroxy alkanoates, and blends thereof.

10. The mitt defined in 8 wherein the impermeable material is rendered compostable by the inclusion of organic material to the polymer matrix of said material and wherein said polymer matrix is chosen from the group consisting of polyethylene, polypropylene, polyesters, polyacrylates, polyamides, and copolymers thereof.
